(19) United States
(12) Patent Application Publication
(10) Pub. No.: US 2025/0332575 A1
(43) Pub. Date: Oct. 30, 2025

(54) Catalyst for Ammonia Synthesis

(71) Applicant: Swansea University, Swansea (GB)

(72) Inventors: Richard Palmer, Swansea (GB); Yubiao Niu, London (GB)

(21) Appl. No.: 18/996,806

(22) PCT Filed: Aug. 1, 2023
(86) PCT No.: PCT/GB2023/052041

§ 371 Date: Jan. 17, 2025

(30) Foreign Application Priority Data
Aug. 2, 2022 (GB) 2211267.6

(51) Int. Cl. B01J 23/745; B01J 37/02; C01C 1/04

(52) U.S. Cl. CPC B01J 23/745; B01J 37/0215; C01C 1/0411

(57) ABSTRACT

The invention concerns a catalyst for the low energy manufacture of ammonia; a process for manufacturing said catalyst; and a process for low energy manufacture of ammonia comprising the use of said catalyst.

### FIELD OF THE INVENTION

The invention concerns a catalyst for the low energy manufacture of ammonia; a process for manufacturing said catalyst; and a process for low energy manufacture of ammonia comprising the use of said catalyst.

### BACKGROUND OF THE INVENTION

Industrial synthesis of ammonia has allowed the global population to explode from 1.6 billion in the early 1900s to approximate 7.7 billion today. This expansion would not have been possible without the rapid advancements in food production fuelled by the widespread use of ammonia-based fertilizers. The current production of ammonia is 176 million tonnes (Mt) per annum, which in turn generates about 500 Mt of CO₂ (˜1.8% of global CO₂ emissions). The Haber-Bosch process (early 20th century) for ammonia production, whilst recognised as one of the key chemical reactions ever developed, accounts for approximately 2% of the energy consumed on our planet. Besides the importance of ammonia as a fertilizer, it is also of great interest in energy storage and transport-a way to store and transport hydrogen fuel. It enables liquid-phase storage under mild conditions with much higher volumetric energy density than hydrogen, and can be shipped as is done now. In addition, ammonia has also attracted attention as an alternative carbon-free fuel source without contributing any CO₂ emissions.

The major challenge in ammonia synthesis is to activate N₂, since the N—N triple bond is one of the most stable chemical bonds in all of chemistry. The current industry process for the production of ammonia is the Haber-Bosch process (N₂+3H₂→2NH₃), which requires high pressure (>15 MPa(150 bar)) and high temperature (>400° C.) reaction conditions, associated with large and centralized infrastructure. However, given the environmental need to alleviate the dependence on fossil fuels, a sustainable ammonia synthesis process is desirable that can take place under low pressure and low temperature conditions and exclusively rely on renewable energy and feedstocks.

Typically, iron has been used in industry as a catalyst for ammonia synthesis, although it is well understood that a wide variety of alternative transition metals, in particular Pt, Mo, Re, Co, Ru and/or Rh, are equally suitable catalysts. Ammonia synthesis under low-temperature and low-pressure is a well-known academic topic [1-3]. Many catalysts have been invented for low energy thermal ammonia synthesis. For example, Masashi Hattori and his coworkers found CaFH is an excellent catalyst for ammonia synthesis at 0.1 MPa (1 bar) and 50° C. [4]. However, the fabrication of such complicated system still remains challenging.

Another alternative technology is electrochemical ammonia synthesis at room temperature and ambient pressure. However, current techniques are at a very early stage, and there are no electrocatalysts available in practice which can produce ammonia in significant yields and with high faradaic efficiencies [5].

We herein disclose a novel catalyst and process for low-energy ammonia synthesis via heterogeneous catalysis. This is achieved by a novel atomic metal catalyst comprising at least one single or a cluster of metal atoms (e.g. a double Iron atom catalyst) supported on the surface of a substrate, which is nonreactive for N₂ reduction and, in a typical but not limiting example, is prepared by the cluster beam deposition technique [6].

Using the catalyst and process disclosed herein, ammonia can be synthesised with low temperature (i.e. ≤250° C., and preferably ≤50° C.) and low pressure (i.e. ≤30 bar, and preferably ≤0.1 MPa (1 bar)). In this manner, this catalyst and process of manufacture paves the way for combination with green hydrogen feedstocks (e.g. water electrolysis) and powered by renewable energy (e.g. solar), to provide for a near zero-carbon process for ammonia synthesis. Further, the simplicity of the set up negates the requirement for complex infrastructure typically associated with high energy incumbent processes of manufacture, offering the possibility for simple and local green ammonia manufacture with a machine powered by renewable energy at the point of use, e.g. on a farm; in this manner, the ammonia can be generated on demand, and introduced into the irrigation system, or stored as ammonia solution, for use as a fertilizer.

### Statements of Invention

The present invention, in its various aspects, is as set out in the accompanying claims.

According to a first aspect, there is provided an atomic metal catalyst, said catalyst comprising a plurality of metal atom clusters supported on the surface of a solid substrate, wherein each metal atom cluster independently comprises or consists of from about 1 to about 500, preferably from about 1 to about 100,more preferably from about 1 to about 50, still more preferably from about 1 to about 10, and most preferably from about 1 to about 6, metal atoms.

Preferably, each of said metal atom clusters comprises or consists of one or more metals selected from: lead (Pb), silver (Ag), gold (Au), platinum (Pt), molybdenum (Mo), tungsten (W), rhenium (Re), cobalt (Co), ruthenium (Ru), rhodium (Rh) and iron (Fe). More preferably, said metal atom clusters comprise or consist of one or more metals selected from: Pt, Mo, Re, Co, Ru, Rh and Fe, and still more preferably from: Mo, Re, Fe and Pt atoms. In particularly preferred examples, the metal atom clusters comprise or consist of Fe atoms.

Said atom clusters may comprise individual atoms or may comprise a mixture or alloy comprising multiple atoms. The metal atoms may be covalently or non-covalently modified and/or may be in an oxidised or reduced form. Preferably, substantially all of the metal atom clusters comprise or consist of the same number and/or type of metal atoms.

In preferred embodiments, the metal atom clusters comprise or consist of a single metal atom, two metal atoms, or three metal atoms. Such metal atom clusters are referred to as single atom catalysts (SACs), double atom catalysts (DACs), and triple atom catalysts (TACs), respectively.

Metal atom clusters comprising two metal atoms, in particular two Fe atoms, i.e. Fe DACs, are particularly preferred.

As would be readily apparent to a person of ordinary skill in the art, the extent of surface coverage by said metal atom clusters on the surface of the substrate can be measured or calculated by a variety of methods. For example, surface coverage is typically measured by projected surface area derived from deposition beam current and X-ray photoelectron spectroscopy (XPS).

Preferably, said metal atom clusters cover from 0.1 to 20%, more preferably from 1 to 10%, and still more preferably from 2 to 5%, of the surface of the substrate.

The solid substrate on which the metal ion clusters are deposited and supported is not particularly limited other in that the substrate is typically non-reactive for N₂ reduction. As would be readily appreciated, suitable solid substrates include, but are not limited to a silicon or carbon-based materials, an oxide, hydride, a nitride or a MXene. However, in preferred embodiments, the substrate is a carbon material, which may be doped with one or more heteroatom (i.e. nitrogen, sulphur or oxygen) containing dopants.

Preferably, said dopant(s) comprise one or more nitrogen heteroatom. More preferably, the substrate comprises a carbon material doped with pyridinic and/or pyrrolic nitrogen atoms. The inclusion of such dopants prevents the surface diffusion of the metal atomic catalysts on the substrate.

Preferably, where a doped carbon material is used as the substrate, the dopant(s) preferably covers from 0.1 to 20%, more preferably from 1 to 10%, and still more preferably from 2 to 5%, of the surface of the substrate. As would be readily apparent to a person of ordinary skill in the art, dopant surface coverage can be measured or calculated by a variety of methods. Examples of suitable methods include electron microscopy, surface spectroscopy (e.g. XPS) and, in the case of powdered substates, Inductively Coupled Plasma Mass Spectrometry (ICP-MS).

As would be readily apparent to a person of ordinary skill in the art, the atomic metal catalysts of the first aspect of the invention may be formed via any conventional physical vapour deposition (PVD) process such as by evaporation, sputtering or pulsed laser deposition. Such PVD processes may comprise a cluster deposition process, wherein metal atom clusters are formed (e.g., via condensation in the gas phase) and then deposited onto the surface of the substrate. Alternatively, said PVD techniques may comprise an atom deposition process, wherein individual metal atoms are deposited, and then form metal atom clusters, on the substrate surface.

Therefore, according to a second aspect of the invention, there is provided a method for preparing the catalyst of the first aspect of the invention by PVD, wherein said metal atom clusters are formed by a cluster deposition process, or wherein said metal atom clusters are formed after deposition on the surface of the substate as single atoms.

In some embodiments, said PVD process is selected from: cluster deposition, evaporation deposition, sputter deposition or pulsed laser deposition.

The atomic metal catalysts are advantageously deposited by a cluster deposition process, preferably a cluster beam deposition process, as such a process allows for tight control of the size of the deposited metal atom clusters. Therefore, according to a preferred embodiment of the second aspect of the invention, there is provided a method for preparing the catalyst of the first aspect by cluster depositing a plurality of metal atom clusters onto the substrate of a solid substrate, wherein the metal ion clusters comprise or consist of from 1 to 10 metal atoms, and wherein the method comprises the following steps:
(i) providing a cluster beam deposition source comprising a plasma sputtering and gas condensation chamber, a mass filter chamber and a deposition chamber;
(ii) disposing in the condensation chamber a metal catalyst target comprising or consisting of metal atoms;
(iii) disposing a solid substrate in the deposition chamber;
(iv) performing a magnetron sputtering step in said condensation chamber that comprises sputtering said metal catalyst target with plasma so as to eject metal atoms, followed by a condensing step in which said ejected atoms form positively charged metal ion clusters by cooling in an inert gas;
(v) separating and selecting on the basis of size metal ion clusters in said mass filter chamber; and
(vi) depositing said metal ion clusters of chosen size on the surface of said substrate in said deposition chamber.

As would be readily apparent to a person of ordinary skill in the art, in step (iv) the metal catalyst target may be sputtered with a plasma derived from any one, or a combination of, inert (e.g. argon) and/or reactive gases. If a reactive gas such as O₂ or N₂ is used, the sputtered particles from the metal catalyst target may undergo a chemical reaction during the sputtering and deposition process, resulting in the deposition of, e.g., metal oxide or metal nitride clusters on the substrate surface.

In preferred embodiments, the metal catalyst target is sputtered with an inert gas (e.g. helium, neon, argon) plasma, most preferably argon plasma.

Preferably, said clusters are formed in step (iv) by condensation in a pressure of helium gas cooled to from about 80 to about 120K.

Preferably, the metal catalyst target comprises or consists of one or more metal selected from lead (Pb), silver (Ag), gold (Au), platinum (Pt), molybdenum (Mo), tungsten (W), rhenium (Re), cobalt (Co), ruthenium (Ru), rhodium (Rh) and iron (Fe). The metal catalyst target may be a single element or may a mixture or alloy comprising multiple elements. The metal catalyst target may comprise covalently or non-covalently modified metal atoms and/or may be in an oxidised or reduced form. More preferably the metal catalyst target comprises or consist of one or more metals selected from Pt, Mo, Re, Co, Ru, Rh and Fe, still more preferably one or more metals selected from Mo, Re, Fe or Pt atoms, and most preferably Fe atoms.

In preferred embodiments, metal ion clusters comprising or consisting of 1, 2 or 3 metal atoms, most preferably Fe atoms, are deposited on the surface of the substrate, i.e. a SAC, DAC or TAC is formed. Most preferably, a DAC is formed by deposition of metal ion clusters comprising or consisting of 2 Fe atoms.

Preferred features in relation to the substrate are as set out above in relation to the first aspect.

In preferred embodiments, the cluster beam deposition source provided in step (i) further comprises an ion optics chamber, which is disposed between the gas condensation chamber and mass filter chamber. In such embodiments, between step (iv) and (v) the method comprises extracting and focussing said metal ion clusters in said optics chamber

The atomic metal catalysts of the first aspect of the invention may be used to catalyse a variety of different chemical reactions. In particular, they are capable of catalysing the synthesis of ammonia (NH₃) via the reduction of N₂ under low temperature and low pressure.

Therefore, according to a third aspect, there is provided a process for the production of ammonia, the process comprising:
(i) disposing in a reactor a catalyst bed comprising an atomic metal catalyst according to the first aspect of the invention;
(ii) passing one or more sources of nitrogen (N₂) and one or more sources of hydrogen (H₂) over said catalyst bed;
(iii) obtaining a product stream comprising ammonia (NH₃).

Preferably, step (ii) is carried out at a temperature at or below 250° C., more preferably at or below 200° C. and still more preferably at or below 150° C. Alternatively or additionally, step (ii) is preferably carried out at a temperature at or above 20° C., and more preferably at or above 30° C.

In exemplary embodiments, step (ii) may be carried out at a temperature in the range of from about 20° C. to about 250° C., such as from about 30° C. to about 75° C., or from about 30° to less than about 50° C. Further, in preferred embodiments, step (ii) is carried out at a pressure of no more than about 3 MPa (30 bar), more preferably no more than about 2 MPa (20 bar), still more preferably no more than about 1 MPa (10 bar), and even more preferably no more than about 0.5 MPa (5 bar). For example, step (ii) may be caried out under standard atmospheric pressure conditions, i.e. about 0.1 MPa (1 bar).

Step (ii) can also be carried out at below atmospheric pressure. For example, catalytic N₂ reduction has been exemplified at pressures from about 250 to about 750 Pa (2.5 to 7.5 mbar), and more preferably about 500 Pa (5 mbar).

In preferred embodiments, the catalyst bed is reduced prior to step (ii). Catalyst reduction can be achieved by, e.g. exposure to H₂ at elevated temperature (e.g. up to about 400° C.).

Preferably, the one or more source of hydrogen is prepared from a green hydrogen feedstock. For example, hydrogen can be prepared from water by electrolysis.

Preferably, the process of the invention is powered by renewable energy, non limiting examples of which include solar and wind power. By combining the use of renewable energy and a green hydrogen feedstock, ammonia can be prepared via a zero-carbon process.

Preferred features of each aspect of the invention may be as described in connection with any of the other aspects.

Throughout the description and claims of this specification, the words “comprise” and “contain” and variations of the words, for example “comprising” and “comprises”, mean “including but not limited to” and do not exclude other moieties, additives, components, integers or steps. Throughout the description and claims of this specification, the term “and/or” includes any and all combinations of one or more of the associated listed elements. Throughout the description and claims of this specification, the singular encompasses the plural unless the context otherwise requires. In particular, where the indefinite article is used, the specification is to be understood as contemplating plurality as well as singularity, unless the context requires otherwise. Throughout the description and claims of this specification, the word “about” means ±5%, alternatively ±2% unless the context otherwise requires.

Throughout the description and claims of this specification, the term “metal atom cluster(s)” and variations thereof includes single metal atom(s) and aggregations of a plurality of metal atoms unless the context otherwise requires.

All references, including any patent or patent application, cited in this specification are hereby incorporated by reference. No admission is made that any reference constitutes prior art. Further, no admission is made that any of the prior art constitutes part of the common general knowledge in the art.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

The Invention will now be described by way of example only with reference to the Examples below and to the following Figures wherein:

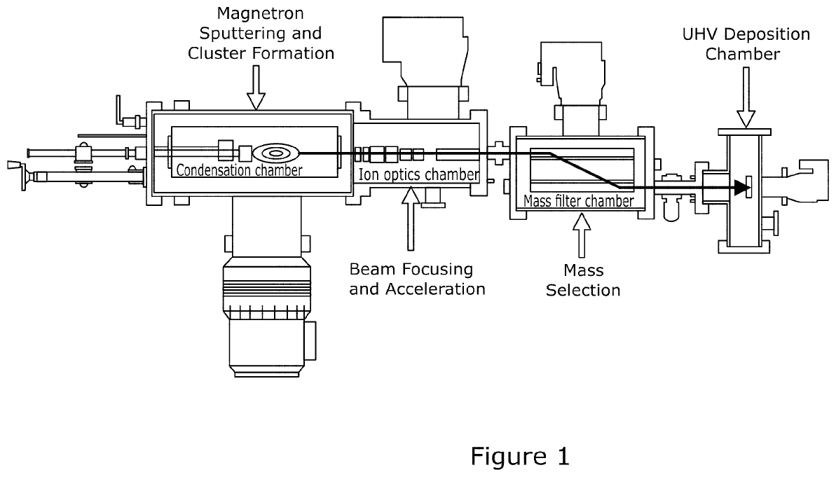

FIG. 1. Schematic illustration of the size selected cluster beam source, which combines the magnetron sputtering technique and gas condensation technique;

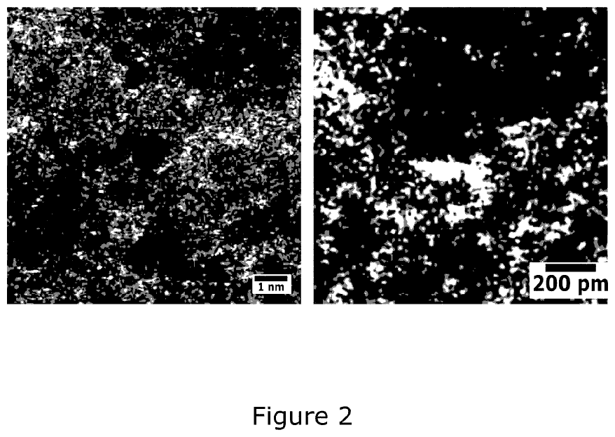

FIG. 2. STEM images of Fe dimer deposited on graphene oxide coated TEM grid;

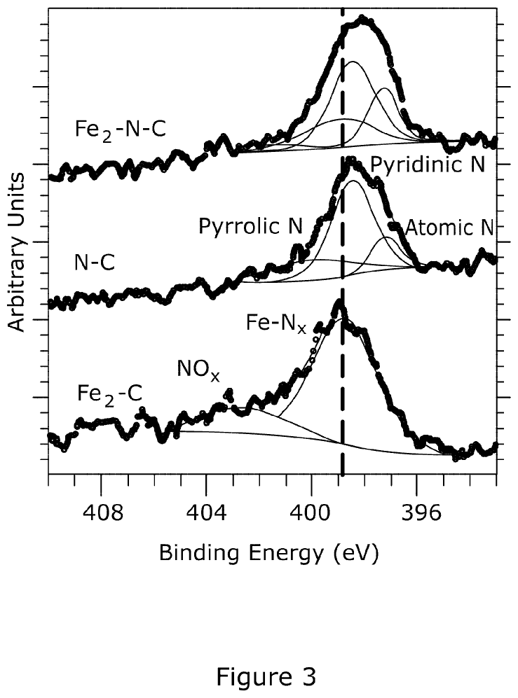

FIG. 3. N1s XPS spectra of Fe dimer on N doped carbon (Fe2—N—C), N doped carbon (N—C) alone and Fe dimer on carbon (Fe2—C);

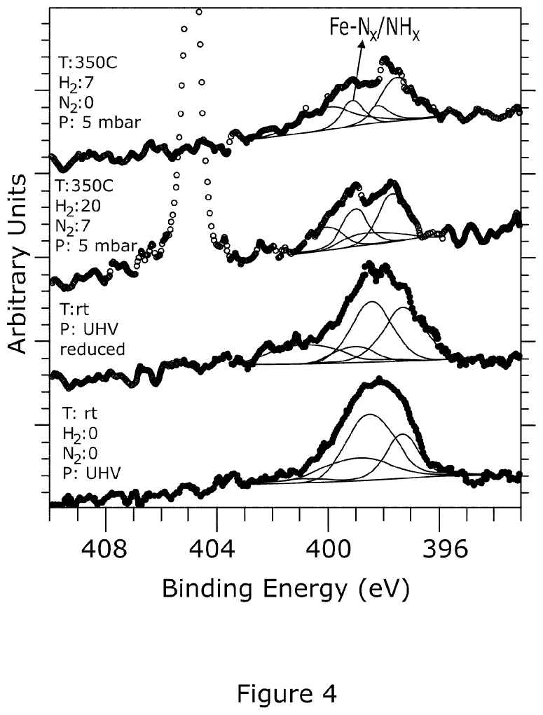

FIG. 4. N1s XPS spectra of Fe₂—N—C system under different conditions;

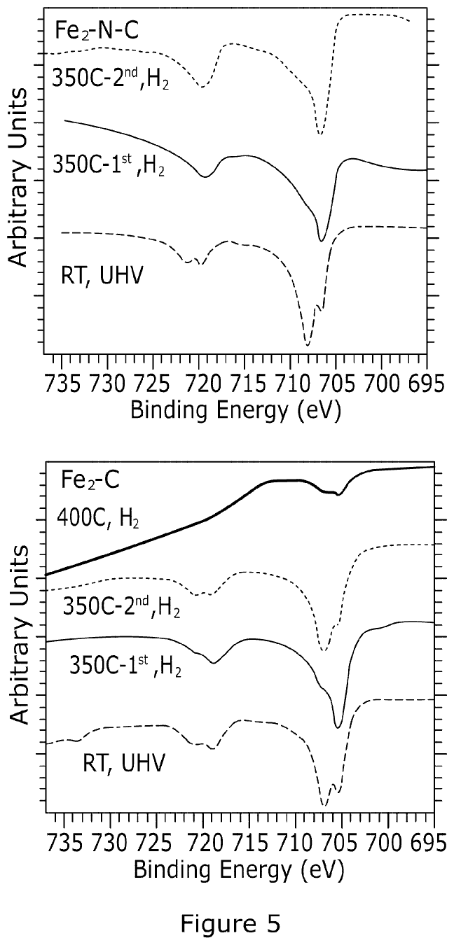

FIG. 5. Fe L-edge NEXAFS of Fe2—N—C system and Fe2—C system under different conditions;

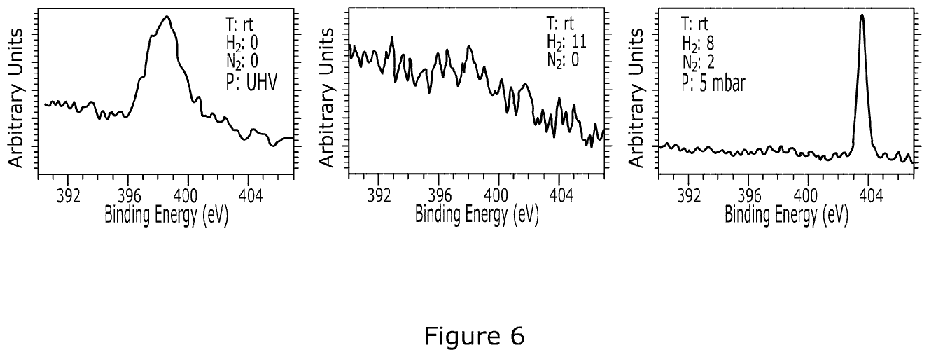

FIG. 6. N1s peak of N doped carbon under different conditions. The temperature (T) is under room temperature (rt) and the flow of H₂ and N₂ is in sccm;

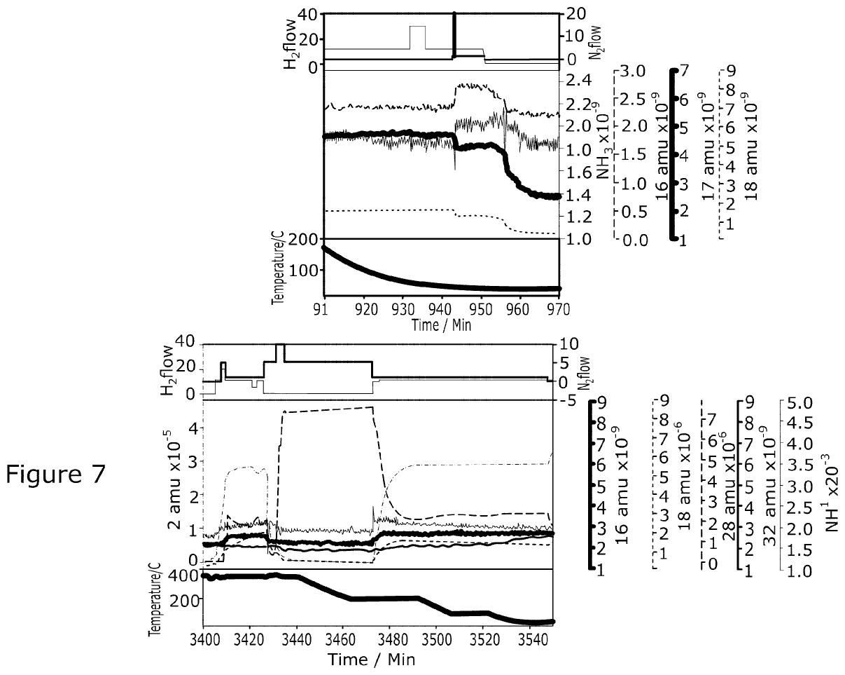

FIG. 7. Partial mass spectra of Fe2—N—C system (top spectrum) and Fe2—C system (bottom spectrum). The flow of H₂ and N₂ is in sccm, and the partial pressure the signal of the mass is in mbar;

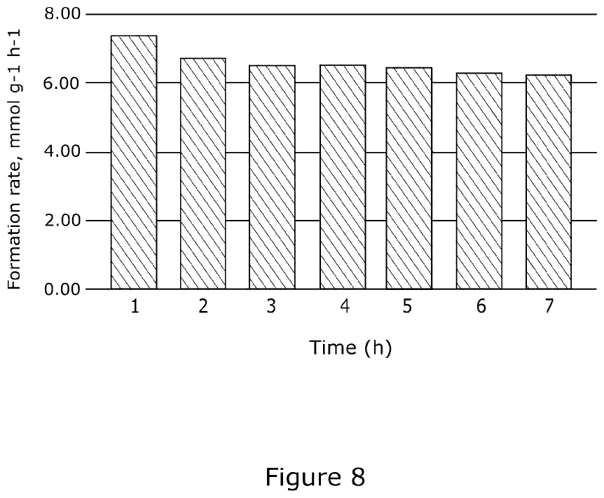

FIG. 8. The catalytic activity of Fe—TiH₂ powder towards ammonia production (200° C.; 10 bar). The metal loading of Fe clusters on TiH₂ powder is normalised to 0.1%. The products were analysed with gas chromatography each hour.

### MATERIALS AND METHODS

The metal catalysts generated for this project were produced at the new Swansea Satellite Nanolab at Diamond Light Source (B07) with the cluster beam deposition technique (instrument built by Swansea).

The cluster beam deposition source (FIG. 1) is a vacuum-based, magnetron-sputtering, gas condensation source, equipped with a lateral time-of-flight mass filter [7]. A metal target is sputtered by a DC Argon plasma; the hot metal atoms are condensed into clusters in a pressure of helium gas cooled to ˜100K by liquid nitrogen; positively charged clusters are extracted and focused by an ion optics into the mass filter for size selection. The resolution of the mass filter was about 1 atom in 20, and the transmission efficiency for the selected mass was >50%. In this project, a series of atomic metal catalysts (Fe and Pt) including metal single atoms, dimers and trimers were produced. The atomic catalysts were deposited onto transmission electron microscopy (TEM) grids (graphene oxide coated grid, 3 mm in diameter) for TEM characterisation [8] (1% surface coverage), and XPS and near edge X-ray absorption fine structure (NEXAFS) study [9] (3%-4% surface coverage). In order to prevent the surface diffusion of atomic catalysts, N-doping (5% surface coverage) of the carbon (graphene oxide) was also conducted prior to the Fe deposition. These materials were imaged by scanning transmission electron microscopy (STEM) at Swansea University and Diamond Light Source.

XPS and NEXAFS experiments under near-ambient pressures were conducted at the B07 beamline at Diamond Light Source. Ambient pressure XPS and NEXAFS, together with multi mass spectrometry systems, were conducted to validate the catalytic activity of different atomic catalysts towards thermochemical ammonia synthesis, by exposing the samples to pure N₂ and N₂+H₂ at temperatures between room temperature and 400° C., and a pressure range of 10⁻⁴ to 10 mbar. The adsorbed reactive intermediates (e.g. *NHx) and molecules were monitored in real time via chemical shifts in the N 1 s core level. The chemical/oxidation state, etc. were studied by monitoring the Fe 2 p core levels.

In a further example, a thin layer of iron clusters (approx. maximum cluster size 1 nm) was deposited onto TiH₂ particles (average particle size 20 μm), enclosed within a metal cup having a stirring function, using a magnetron sputtering technique. Then, the catalytic activity of the iron cluster coated TiH₂ particles towards ammonia production was measured using a high pressure reactor, and the products were analysed using gas chromatography or liquid chromatography. Specifically, the reaction was tested at a temperature of 200° C. and a pressure of 1 MPa (10 bar) in a mixture of N₂ (10 ml/min) and H₂ (30 ml/min) following dilution of the catalyst with SiC powder to improve the heat transfer.

### RESULTS

Images after deposition of the Fe dimers fabricated by cluster beam deposition are shown in FIG. 2. As the landing energy of those dimer is 9 eV per atom, they may break into single atoms on surface impact. The bright dots shown in the STEM images are Fe dimers and single atoms.

Three samples were tested for ammonia synthesis, namely, Fe dimers on an N-doped carbon (graphene oxide) support (Fe₂—N—C), the N-doped carbon support itself (N—C) and Fe dimers on the carbon support without doping (Fe₂—C). FIG. 2 shows the N1s XPS spectra of those samples under vacuum conditions. The deposition chamber of the cluster source was vented with N₂ gas after cluster deposition and then the samples were transferred (in air) to the beamline for measurement. The N in the bare N—C system is from the N doping process. Both pyridinic N and pyrrolic N are found on the surface of this support. The addition of Fe dimers on the N doped carbon introduces a new peak corresponding to Fe—Nx species. This implies that the Fe dimer is very active for N₂ fixation. Once the N—C system is decorated by Fe dimers, the N₂ molecules are adsorbed on the surface of those dimers. This can also be confirmed by the experiments with the Fe₂—C system without dosing N₂ into the chamber. Here there is no N doping and the surface N is from the chamber venting process and air transfer.

All the samples were tested for ammonia synthesis under mixed N₂ and H₂ gas atmosphere, after sample reduction in H₂ at temperature up to 400° C. FIG. 4 shows the evolution of the N1s peak under different conditions for the Fe₂—N—C system. The intensity of Fe—Nx/NHx increases once N₂ is introduced into the chamber, which means the N—N triple bond splits and Fe—Nx or NHx species are formed. The intensity of this peak decreases when N₂ is depleted in the chamber.

The reduction process of the Fe dimer catalysts on N-doped carbon and bare carbon were monitored with Fe L-edge NEXAFS spectra as shown in FIG. 5. Both Fe²⁺ and Fe³⁺ states are found in the samples after deposition of metal atom clusters. The Fe³⁺ can be quickly reduced to Fe²⁺ in an H₂ atmosphere (e.g. 500 Pa (5 mbar), at a temperature of 300° C. or above). Reduction to Fe²⁺ was similarly achieved for the Fe₂—N—C system. In the case of the Fe₂—C system, the Fe³⁺ became much more difficult to reduce to Fe₂₊ in subsequent reduction cycles, implying that there is change in the surface morphology, e.g. sintering, or atomic configuration during the heating process.

The presence of the N1s peak (N—C sample) shown in FIG. 6 before conducting reduction indicates the successful doping of N into carbon (graphene oxide). This peak disappears in the reduction process. The formation of ammonia is detected in this process, which means the bonds between the doped N atoms and the carbon support are not strong enough to prevent the N forming NH₃ in H₂ atmosphere. The N peak cannot be recovered by reintroducing N₂ gas as there is no catalyst for N—N bond splitting.

The catalytic activity of Fe dimers was monitored by mass spectrometry as shown in FIG. 7. The mass of ammonia is 17 amu. However, water (18 amu) also creates a secondary signal of 17 amu, so the 17 amu is not a good indicator of formation of ammonia. As ammonia forms a strong signal at 16 amu in mass spectrometry, here we use 16 amu as the indication of ammonia. The “NH₃” signal shown in pink was obtained from the subtraction of the contribution of water at 17 amu. The mass spectrometry was done in a pressure of 5 mbar in the main chamber. In the Fe₂—N—C system, it can be seen that the ammonia synthesis reaction can be triggered by introducing a minimal flow of N₂ (1 sccm) to the chamber with a temperature <50° C. The successful synthesis of ammonia can be confirmed by the signal increase of both 16 amu and “NH₃” signal (described above). Under high temperature testing, the Fe₂—C system shows similar behaviour as the Fe₂—N—C system for the formation of ammonia.

FIG. 8 shows the catalytic activity of the Fe—TiH₂ particle system towards ammonia production. Notably, the catalyst was seen to stabilise during the first two hours of the reaction (as shown in the drop of catalytic activity) before stabilising for the remaining duration of measurement (7 hours).

### SUMMARY

Few atom Fe catalysts (1, 2 and 3 atoms) have been successfully synthesised and deposited with the cluster beam deposition technique. So far the Fe dimers have been tested for ammonia synthesis on two different supports, including carbon and N-doped carbon. Both the Fe₂—N—C system and the Fe₂—C system show catalytic activity for N₂ reduction to ammonia. Compared with the Fe2—C system, the Fe2—N—C system is much more stable as shown when subjected to high temperature reduction cycles. The Fe dimers can catalyse this reaction with pressure as low as 5 mbar, with higher pressures expected to achieve higher yields, and temperature <50° C.

Fe clusters (approx. maximum cluster size 1 nm) were also deposited by magnetron sputtering onto TiH₂ particles, and the resultant Fe catalyst was shown to be catalytically active towards ammonia production under milder conditions than those conventionally used in the Haber-Bosch process.

### REFERENCES

[1] Rod, T. H., Logadottir, A., & Nørskov, J. K. The Journal of Chemical Physics, 2000, 112 (12), 5343-5347.
[2] Wang, P., Chang, F., Gao, W., Guo, J., Wu, G., He, T., & Chen, P. Nature chemistry, 2017, 9 (1), 64-70.
[3] Ogura, Y., Tsujimaru, K., Sato, K., Miyahara, S. I., Toriyama, T., Yamamoto, T., & Nagaoka, K. ACS Sustainable Chemistry & Engineering, 2018, 6 (12), 17258-17266.
[4] Hattori, M., Iijima, S., Nakao, T., Hosono, H., & Hara, M. Nature communications, 2020, 11 (1), 1-8.
[5] Singh, A. R.; Rohr, B. A.; Schwalbe, J. A.; Cargnello, M.; Chan, K.; Jaramillo, T. F.; Chorkendorff, I.; Nørskov, J. K. ACS Catalysis 2016, 7, (1), 706-709.
[6] Palmer, R. E., Cai, R., & Vernieres, J. Accounts of Chemical Research, 2018, 51 (9), 2296-2304.
[8 ] Pratontep, S., Carroll, S. J., Xirouchaki, C., Streun, M., & Palmer, R. E. Review of Scientific Instruments, 2005, 76 (4), 045103.
[8] Niu, Y., Schlexer, P., Sebok, B., Chorkendorff, I., Pacchioni, G., & Palmer, R. E. Nanoscale, 2018, 10 (5), 2363-2370.
[9] Held, G., Venturini, F., Grinter, D. C., Ferrer, P., Arrigo, R., Deacon, L., & Scott, S. Journal of synchrotron radiation, 2020, 27 (5), 1153-1166.

1. An atomic metal catalyst, said catalyst comprising a plurality of metal atom clusters supported on the surface of a solid substrate, wherein each metal atom cluster independently comprises from about 1 to about 500 metal atoms.

2. The atomic metal catalyst according to claim 1, wherein each metal atom cluster independently comprises from about 1 to about 10 metal atoms.

3. The atomic metal catalyst according to claim 1, wherein each of said metal atom clusters comprises one or more metals selected from: lead (Pb), silver (Ag), gold (Au), platinum (Pt), molybdenum (Mo), tungsten (W), rhenium (Re) cobalt (Co), ruthenium (Ru), rhodium (Rh) and iron (Fe).

4. The atomic metal catalyst according to claim 3, wherein each of said metal atom clusters comprises one or more metals selected from Pt, Mo, Re, Co, Ru, Rh and Fe.

5. The atomic metal catalyst according to claim 4, wherein each of said metal atom clusters comprises Fe atoms.

6. The atomic metal catalyst according to claim 1, wherein said metal atom clusters cover from 0.1 to 20% of the surface of the substrate.

7. The atomic metal catalyst according to claim 1 ms, wherein said substrate is a silicon or carbon-based material, an oxide, a hydride, a nitride or a MXene.

8. The atomic metal catalyst according to claim 7, wherein said substrate is a carbon material.

9. The atomic metal catalyst according to claim 8, wherein said carbon material is doped with one or more heteroatom containing dopants, optionally wherein said dopant(s) cover from 0.1 to 20% of the surface of the substrate.

10. A method for preparing the catalyst according to claim 1, wherein said method is a cluster deposition process in which said metal atom clusters are formed and then deposited onto the surface of said substrate; or wherein said method is an atom deposition process in which individual metal atoms are deposited, and then form metal atom clusters, on said substrate surface.

11. The method according to claim 10, comprising depositing a plurality of metal atoms and/or metal atom clusters onto the surface of a solid substrate by a cluster deposition, evaporation deposition, sputter deposition or pulsed laser deposition process, wherein each metal atom cluster independently comprises from about 1 to about 500 metal atoms.

12. The method according to claim 11, wherein each metal atom cluster independently comprises from about 1 to about 10 metal atoms.

13. The method according to claim 10, wherein said method is a cluster deposition process, the method comprising the following steps:
(i) providing a cluster beam deposition source comprising a plasma sputtering and gas condensation chamber, a mass filter chamber and a deposition chamber;
(ii) disposing in the condensation chamber a metal catalyst target comprising metal atoms;
(iii) disposing a solid substrate in the deposition chamber;
(iv) performing a magnetron sputtering step in said condensation chamber that comprises sputtering said metal catalyst target with plasma so as to eject metal atoms, followed by a condensing step in which said ejected atoms form positively charged metal ion clusters by cooling in an inert gas;
(v) separating and selecting on the basis of size metal ion clusters in said mass filter chamber; and
(vi) depositing said metal ion clusters of chosen size on the surface of said substrate in said deposition chamber.

14. The method according to claim 13, wherein said metal atom target comprises one or more metal selected from: lead (Pb), silver (Ag), gold (Au), platinum (Pt), molybdenum (Mo), tungsten (W), rhenium (Re), cobalt (Co), ruthenium (Ru), rhodium (Rh) and iron (Fe).

15. The method according to claim 14, wherein said metal atom target comprises one or more metal selected from Pt, Mo, Re, Co, Ru, Rh and Fe.

16. The method according to claim 15, wherein said metal atom target comprises Fe atoms.

17. The method according to claim 10, wherein said substrate is a silicon or carbon-based material, an oxide, a hydride, a nitride or a MXene.

18. The method according to claim 17, wherein said substrate is a carbon material, doped with one or more heteroatom containing dopants.

19. The method according to claim 13, wherein in step (iv) said metal catalyst target is sputtered with an inert gas, preferably argon, plasma, and/or wherein said clusters are formed in step (iv) by condensation in a pressure of helium gas cooled to about 80 to about 120 K.

20. The method according to claim 13, wherein in step (vi) metal ion clusters comprising 1, 2 or 3 metal atoms are deposited on the surface of the substrate.

21. A method for producing ammonia, the method comprising:
(i) disposing in a reactor a catalyst bed comprising an atomic metal catalyst according to claim 1;
(ii) passing one or more sources of nitrogen (N₂) and one or more sources of hydrogen (H₂) over said catalyst bed;
(iii) obtaining a product stream comprising ammonia (NH₃).

22. The method according to claim 21, wherein step (ii) is carried out at a temperature in the range of from about 20° C. to about 250° C., and/or at a pressure of no more than about 3 MPa (30 bar).

23. The method according to claim 22, wherein step (ii) is carried out at a temperature in the range of from about 30° C. to about 75° C., and/or at a pressure of no more than about 1 MPa (10 bar).

24. The method according to claim 21, wherein the catalyst bed is reduced prior to step (ii), by exposure to H₂ at a temperature up to about 400° C.

25. The method according to claim 21, wherein the one or more source of hydrogen is prepared from a green hydrogen feedstock, and/or the method is powered by renewable energy.

26. A method for producing ammonia via heterogeneous catalysis, the method comprising:
(i) disposing in a reactor a catalyst bed comprising an atomic metal catalyst;
(ii) passing nitrogen (N₂) and hydrogen (H₂) over said catalyst bed;
(iii) obtaining a product stream comprising ammonia (NH₃);
wherein the atomic metal catalyst comprises a plurality of metal atom clusters supported on the surface of a solid substrate, wherein each metal atom cluster independently consists of from 1 to 500 metal atoms, wherein the number of metal atoms is determined by STEM;
wherein the said substrate is a silicon or carbon-based material, an oxide, a hydride, a nitride or a MXene;
wherein each of said metal atom clusters comprises platinum (Pt), molybdenum (Mo), rhenium (Re) cobalt (Co), ruthenium (Ru), rhodium (Rh) and iron (Fe).”
